(19) United States
(12) Patent Application Publication
(10) Pub. No.: US 2026/0346834 A1
(43) Pub. Date: Nov. 5, 2026

(54) SYSTEMS AND METHODS FOR OCCUPANCY-BASED AUTONOMOUS VEHICLE PARKING

(71) Applicant: Honda Motor Co., Ltd., Tokyo (JP)

(72) Inventors: Farhad Nawaz SAVVAS SADIQ ALI, Philadelphia, PA (US); Jovin J. D'SA, San Jose, CA (US); Faizan Muhammad TARIQ, San Jose, CA (US); Sangjae BAE, Mountain View, CA (US); David F. ISELE, Sunnyvale, CA (US); Avinash SINGH, Santa Clara, CA (US)

(21) Appl. No.: 19/663,813

(22) Filed: Apr. 30, 2026

Related U.S. Application Data
(60) Provisional application No. 63/797,764, filed on Apr. 30, 2025.

(51) Int. Cl. B60W 30/06; B60W 50/00; B60W 60/00; G06V 20/58

(52) U.S. Cl. CPC B60W 30/06; B60W 50/0097; B60W 60/0011; B60W 60/0015; B60W 60/0021; B60W 60/00274; G06V 20/586; B60W 2554/4045; B60W 2556/40

(57) ABSTRACT

A computer system for executing parking operations for a first vehicle is provided. The computer system is configured to: (i) receive sensor data from one or more sensors associated with the first vehicle, (ii) generate an occupancy map including a plurality of parking spaces, (iii) determine an occupancy status for at least one detected parking space within a field-of-view (FoV), (iv) determine, based on the received sensor data, a predicted trajectory of at least one dynamic agent, (v) determine, a likelihood that the occupancy status will change within a given time period, (vi) update the occupancy map based on (a) the occupancy status and (b) the determined likelihood that the occupancy status will change within the given time period, (vii) generate a trajectory for the first vehicle based on the updated occupancy map; and (viii) control operation of the first vehicle based on the trajectory.

### CROSS-REFERENCE TO RELATED APPLICATIONS

This application claims the benefit of priority to U.S. Provisional Patent Application No. 63/797,764, filed Apr. 30, 2025, and entitled “SYSTEMS AND METHODS OF OCCUPANCY-AWARE TRAJECTORY PLANNING FOR AUTONOMOUS VALET PARKING,” the entire contents and disclosures of which are hereby incorporated herein in their entirety.

### FIELD OF THE DISCLOSURE

The field of the disclosure relates generally to systems and methods for vehicle trajectory planning, and more specifically, to occupancy-based trajectory planning and vehicle navigation in parking environments.

### BACKGROUND

Autonomous valet parking has emerged as a desired application in intelligent transportation systems, offering potential improvements in parking efficiency and reducing the inconvenience experienced by drivers in urban environments. However, deploying autonomous valet systems in real-world scenarios presents substantial challenges, notably due to uncertainties inherent in dynamic environments, such as moving vehicles and pedestrians, and the limited sensor range of autonomous vehicles.

Prior research in autonomous parking often has simplified assumptions that undermine realistic applicability. For instance, existing trajectory planners may assume a predefined reference trajectory and focus on static obstacle avoidance or dynamic obstacle avoidance only for two-vehicle scenarios, neglecting the problem of identifying an optimal spot dynamically. Moreover, occupancy prediction methods traditionally rely on basic Bayesian filtering techniques without considering the influence of dynamic agents. Existing observation models assume constant sensor confidence irrespective of distance from the ego vehicle, disregarding the practical degradation of observation reliability with increased range.

### BRIEF DESCRIPTION

In one aspect, a computer system for executing parking operations for a first vehicle is provided. The computer system may include at least one processor and at least one memory in communication therewith. The at least one processor may be programmed to: (i) receive sensor data from one or more sensors associated with the first vehicle, wherein the received sensor data is limited to a field-of-view (FoV) of the one or more sensors, (ii) generate, based on the received sensor data, an occupancy map including a plurality of parking spaces, (iii) determine an occupancy status for at least one detected parking space within the FoV, (iv) determine, based on the received sensor data, a predicted trajectory of at least one dynamic agent, (v) determine, based on the predicted trajectory of the at least one dynamic agent, a likelihood that the occupancy status will change within a given time period, (vi) update the occupancy map based on (a) the occupancy status and (b) the determined likelihood that the occupancy status will change within the given time period, (vii) generate a trajectory for the first vehicle based on the updated occupancy map; and (viii) control operation of the first vehicle based on the trajectory.

In another aspect, a computer-implemented method for executing parking operations for a first vehicle is provided. The computer-implemented method may be performed by at least one processor in communication with at least one memory. The computer-implemented method may include: (i) receiving sensor data from one or more sensors associated with the first vehicle, wherein the received sensor data is limited to a field-of-view (FoV) of the one or more sensors, (ii) generating, based on the received sensor data, an occupancy map including a plurality of parking spaces, (iii) determining an occupancy status for at least one detected parking space within the FoV, (iv) determining, based on the received sensor data, a predicted trajectory of at least one dynamic agent, (v) determining, based on the predicted trajectory of the at least one dynamic agent, a likelihood that the occupancy status will change within a given time period, (vi) updating the occupancy map based on (a) the occupancy status and (b) the determined likelihood that the occupancy status will change within the given time period, (vii) generating a trajectory for the first vehicle based on the updated occupancy map; and (viii) controlling operation of the first vehicle based on the trajectory.

In another aspect, at least one non-transitory computer readable storage media having computer-executable instructions embodied thereon for path planning for a first vehicle is provided. When executed by at least one processor in communication with at least one memory, the computer-executable instructions may cause the at least one processor to: (i) receive sensor data from one or more sensors associated with the first vehicle, wherein the received sensor data is limited to a field-of-view (FoV) of the one or more sensors, (ii) generate, based on the received sensor data, an occupancy map including a plurality of parking spaces, (iii) determine an occupancy status for at least one detected parking space within the FoV, (iv) determine, based on the received sensor data, a predicted trajectory of at least one dynamic agent, (v) determine, based on the predicted trajectory of the at least one dynamic agent, a likelihood that the occupancy status will change within a given time period, (vi) update the occupancy map based on (a) the occupancy status and (b) the determined likelihood that the occupancy status will change within the given time period, (vii) generate a trajectory for the first vehicle based on the updated occupancy map; and (viii) control operation of the first vehicle based on the trajectory.

### BRIEF DESCRIPTION OF THE DRAWINGS

FIG. 1 is a schematic diagram of a vehicle control system in accordance with an exemplary embodiment of the present disclosure.

FIG. 2 is a simplified view of an exemplary environment (e.g., a parking lot) in which a vehicle is navigating.

FIG. 3 is a schematic diagram of a vehicle in accordance with an exemplary embodiment of the present disclosure.

FIG. 4 depicts one view of data associated with an occupancy map in accordance with an exemplary embodiment of the present disclosure.

FIGS. 5A-5F depict graphs of various metrics associated with trajectories generated by, for example, the vehicle control system of FIG. 1.

FIG. 6 is a flow diagram of a method of controlling navigation of a vehicle in accordance with an exemplary embodiment of the present disclosure.

FIG. 7 is a schematic diagram of an exemplary computer device that may be used in the control system shown in FIG. 1.

### DETAILED DESCRIPTION

The systems and methods may include a computationally efficient probabilistic estimator for parking spot occupancy over a future horizon, leveraging uncertain motion predictions and velocities of dynamic agents in the scene. The estimator may use distinct update equations for initially vacant and occupied spots to more accurately capture their occupancy dynamics. A limited Field-of-View (FoV) observation model may be incorporated, introducing distance-based uncertainty in spot occupancy estimates to reflect the sensing limitations of an ego vehicle. Furthermore, the estimator may be integrated with a strategy planner that either navigates the ego vehicle to an ideal available spot or actively explores the lot by maximizing information gain.

An autonomous vehicle may receive perception data from sensors, estimate current and future occupancy of parking spaces based on the state of the parking spaces and the state of one or more dynamic agents, and generate a plan to either execute a parking operation for the vehicle or continue exploring the lot. The system may generate one or more candidate vehicle trajectories and control the vehicle according to one of the one or more candidate trajectories.

The system may receive sensor data from sensors on the vehicle and/or may receive a map of the environment from an external source, such as an external map database. The system may generate and/or update an occupancy map of the environment including estimated occupancy statuses of parking spaces based on the sensor data. The system may further generate future occupancy predictions for each parking space based on the states of dynamic agents in the environment (e.g., the speed and heading of other vehicles, pedestrians, etc.). In some embodiments, the received sensor data and/or the calculations for occupancy status and future occupancy predictions may be generated for only a partial field of view (FoV) of the vehicle sensors (e.g., an area in close proximity to the vehicle) to reduce computational resources required and maintain a high-level of accuracy for calculations, as sensor data may become less accurate with distance from the vehicle. The system may generate confidence values associated with the occupancy status and the future occupancy prediction based on, for example, the proximity of the observed area to the vehicle and/or whether the area is fully observed or partially observed (e.g., part of the area is obscured from sensors).

Using the updated occupancy map, the vehicle may determine if any parking spaces are candidates for parking, at least based on the occupancy status, the future occupancy prediction, and/or the confidence value associated with the observations for each spot (e.g., by comparing the calculations to one or more threshold values). For example, spaces that are observed with high confidence, are currently vacant, and likely to stay vacant may be determined as candidate spots. In some embodiments, the system may only assess spots and/or dynamic agents within the partial FOV of the vehicle to reduce computation time and improve the accuracy of candidate spot assessment.

Upon determining a list of candidate spots, the system may generate a trajectory based on the candidate spots. The trajectory generation may be informed by a cost function, where the cost function may seek to account for total time, waiting time, distance, safety, and/or smoothness (e.g., braking, acceleration, turning) of the trajectory. The system may select a trajectory of a plurality of generated trajectories based on which trajectory is associated with a lowest output from the cost function or based on some other criteria. The trajectory may include waiting instructions, which cause the vehicle to wait a period of time before or during execution of the trajectory. Waiting instructions are useful in circumstances in which a vehicle may have to wait for a dynamic agent to move out of the planned trajectory, wait for a space to become vacant, or in situations in which the vehicle may wait for an occupied candidate space to become vacant.

If no valid candidate parking space exists (e.g., there are no vacant spaces or all trajectories are blocked for a threshold time), the system may initiate an exploration mode to control the vehicle to explore the parking lot. The system may include an entropy value associated with each parking space, where the entropy value represents the certainty of observations associated with the parking space. For example, the entropy values may be based on the time since the spot was last observed and the confidence value associated with observations of the spot (e.g., whether the spot was fully observed, if the spot was observed within the partial FoV or outside the partial FoV, the clarity of sensor data associated with the observations of the space, etc.). The system may determine a plurality of candidate trajectories for exploring the lot, such as “turn right”, “turn left” or “go straight”. The system analyzes each trajectory to control the vehicle based on the trajectory that will result in the highest total reduction in entropy values, and controls the vehicle according to that trajectory. The system then repeats the above processes, collecting new data and determining whether candidate parking spaces exist until a successful parking operation is executed.

The technical effect achieved by this system may be at least one of: (i) improving an ability of a vehicle to autonomously execute an autonomous parking operation by accounting for dynamic agents; (ii) improving an ability of a vehicle to autonomously execute an autonomous parking operation by accounting for future space occupancy predictions; (iii) reducing the computational resources needed to determine candidate vehicle trajectories by filtering processed sensor data to a partial FoV while improving the accuracy of observations by accounting for degrading sensor reliability with distance; (iv) improving safety of generated vehicle trajectories by reducing the distance to dynamic agents within the environment; and (v) improving the ability of a vehicle to autonomously navigate a parking environment by accounting for entropy in past observations.

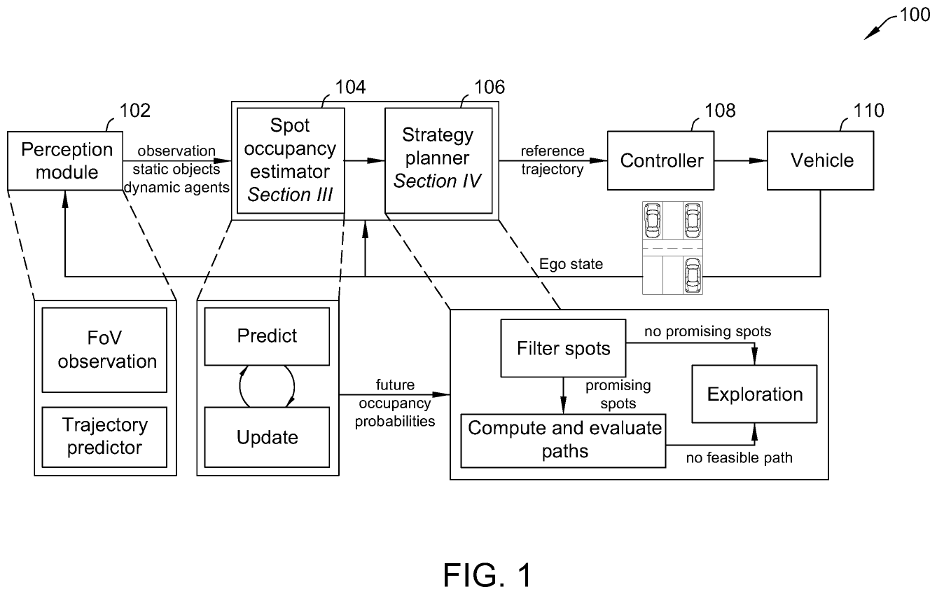

Turning now to the Figures, FIG. 1 is a simplified view of an example system 100 for conducting parking operations for an autonomous vehicle.

A perception module 102 of system 100 may collect sensor data from sensors associated with an autonomous vehicle (e.g., sensors 305), such as LiDAR, camera data (e.g., video and/or images), and/or other known sensors used for vehicle pathing. In the exemplary embodiment, system 100 is configured to collect data from only sensors local to a vehicle, but in some embodiments, system 100 may collect data from external sources, such as map data from an open source street map system or other mapping system. In some embodiments, system 100 may limit a field of view (FoV) of the sensors or may limit or remove areas outside a predetermined FoV from consideration in further steps. By limiting the FoV from the maximum perceivable area, the system reduces distance-based uncertainty in calculations and determinations made by system 100, improving the accuracy of spot prediction while reducing computational memory needed to store sensor data and computation resources needed to generate trajectories (as described below).

Perception module 102 may further use an AI model or an object recognition process to generate observations based on the collected sensor data, such as the locations and/or properties (e.g., speed, heading, etc.) of objects, vehicles, and/or pedestrians in the collected sensor data.

Collected sensor data and corresponding observations may be used by spot occupancy estimator 104 and strategy planner 106.

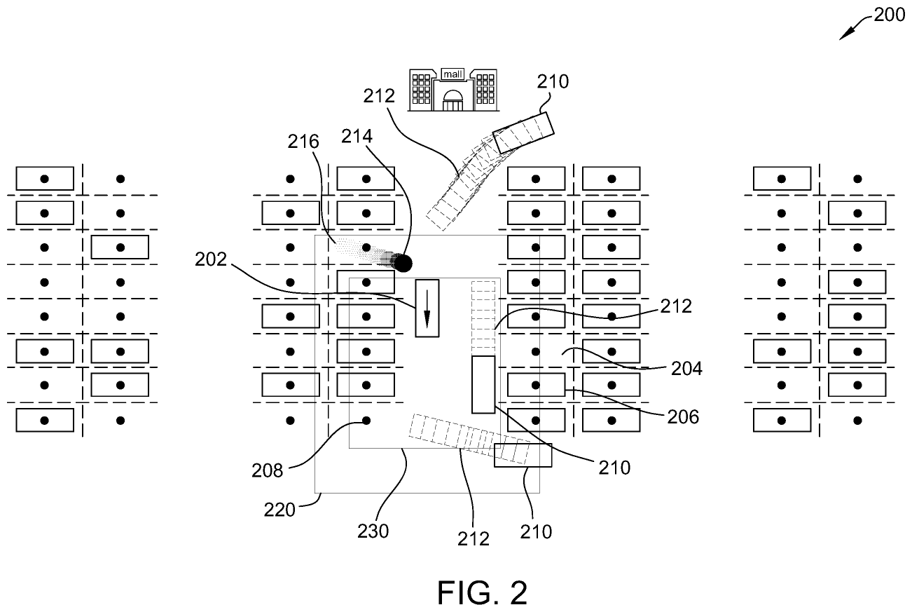

Spot occupancy estimator 104 generates and/or updates an occupancy map of the environment of the vehicle. The occupancy map may include data about the layout of the parking environment. For example, the occupancy map may include the locations of lanes, parking spaces, and/or values associated with parking spaces, such as occupancy statuses, future occupancy predictions, entropy values, and/or confidence values associated with such values. Spot occupancy estimator 104 may determine locations of parking spaces (e.g., centroids 208 of each space as shown in FIG. 2). Spot occupancy estimator 104 may determine whether each parking space is currently vacant based on collected sensor data and may generate a corresponding confidence value for the detected occupancy based on the position of the spot relative to the FoV of the vehicle and an observation state for each known spot, including whether the spot is fully observed, unobserved, or partially observed. Spot occupancy estimator 104 may further generate predicted trajectories for one or more dynamic agents based on the speed, heading, past behavior, and/or location of the dynamic agent.

Spot occupancy estimator 104 may further generate a future spot occupancy prediction for each spot, including whether a vacant spot will remain vacant or whether a non-vacant spot will remain non-vacant. The spot occupancy prediction may include a likelihood that the spot will experience a change in occupancy status over and given period of time. The spot occupancy prediction may be generated using a recursive belief estimator (described in more detail further herein) and may take into account the currently detected occupancy, corresponding confidence values, and/or the states of dynamic agents (e.g., the speed and heading of pedestrians and other vehicles). In some embodiments, the spot occupancy prediction may be generated further based on predicted average arrival rates and predicted average departure rates, which may be predetermined, may be generated based on collected sensor data, and/or may be retrieved from an external database. Spot occupancy estimator 104 may recursively update the spot occupancy prediction for each spot periodically or continuously as more sensor data is received by perception module 102. In some embodiments, different update rules may be used for initially vacant spaces and initially occupied spaces. For example, for initially vacant spots, a first update rule may be used to emphasize incoming occupancy, while for initially occupied spots, a second update rule may be used to emphasize potential departures of an occupying agent (see, for example, the exemplary belief equations described further herein).

Strategy planner 106 may use the spot occupancy estimation to generate a reference trajectory for the autonomous vehicle. For example, strategy planner 106 may analyze the updated occupancy map, including the determined spot occupancy values and spot occupancy predictions for each spot, may select a corresponding action based on the values (e.g., park, wait, explore), and may generate a corresponding trajectory for the autonomous vehicle to follow. In some embodiments, when determining whether to initiate a parking operation, strategy planner 106 may consider only spots within the FoV of the vehicle or the partial FOV of the vehicle to increase the accuracy of the parking determination and reduce computational resources (memory and processing power) required to determine a trajectory. Strategy planner 106 may filter candidate spots inside the FoV based on the occupancy predictions in the occupancy map, such that strategy planner 106 considers only (i) spots that are initially vacant and likely to stay vacant and (ii) spots that are currently occupied but likely to become unoccupied. Strategy planner 106 may adjust the filtering to suit one or more vehicle objectives, such as prioritizing fast parking, prioritizing spaces close to a structure, or prioritizing spaces far from other vehicles. By filtering the number of candidate spots to a reduced subset of spots, system 100 conserves computational resources needed to generate trajectories, as described below.

Strategy planner 106 may generate a candidate trajectory for each of the filtered candidate spots. When generating trajectories, strategy planner 106 may use the collected dynamic agent information (e.g., predicted trajectory, speed, location, and/or heading) and static object locations to generate vehicle trajectories. For each candidate trajectory, strategy planner 106 may generate a cost function to evaluate one or more criteria of the trajectory. The cost function may include an efficiency weight (e.g., time and distance), a safety weight (e.g., collision avoidance, distance from obstacles), and/or a smoothness weight (e.g., acceleration and gear changes). The cost function may further include a barrier cost that penalizes proximity to obstacles and dynamic agents. Waiting time may further be included in the cost function, and waiting time may be constrained to a maximum threshold value, such that strategy planner 106 will only consider trajectories that are below the maximum threshold wait time. After calculating cost values for each trajectory, strategy planner 106 may select a trajectory that has the lowest cost value and avoids all obstacles (e.g., maintains a threshold distance to all static and dynamic agents). In some embodiments, the generated trajectory may include a “wait” trajectory that instructs the vehicle to wait and continue gathering more information. The “wait” trajectory may be selected if, for example, there is a high likelihood of a nearby parking space becoming available in the near future and the vehicle can wait for the space to become vacant, or as a fallback if no safe trajectory can be planned.

In some cases, strategy planner 106 may determine that there are no candidate spaces, for example, no candidate parking spaces are within the vehicle FoV as all spaces are non-vacant and are not predicted to become vacant. If there are no candidate spaces, strategy planner 106 may instead generate an exploration trajectory. Strategy planner 106 may then generate an exploration trajectory with the objective of maximizing information gain about spot occupancy. Strategy planner 106 may generate a subset of options based on the layout of the parking environment, for example, in a typical parking lot, the subset of options may include “go straight”, “turn right”, and “turn left”. To account for more complex parking areas, such as parking garages with an element of verticality, strategy planner 106 may generate additional more complex options, such as “navigate up a level” or “navigate down a level”.

System 100 may use one or more pathfinding algorithms (described in more detail further herein) to generate a candidate exploration trajectory for each option, where the candidate exploration trajectory may include an exploration duration (based on distance and/or time). Strategy planner 106 computes an information gain of each candidate exploration trajectory by determining an entropy value associated with each parking space, and determining which trajectory results in the greatest reduction in entropy. Entropy values may be based, for example, on the time since a spot was last observed, the confidence value associated with the previous observation (e.g., a spot that was last observed a long time ago with a low confidence value has a high entropy value), and/or other contextual data, including average arrival and departure rates for spots. Strategy planner 106 may further simulate future observations for each trajectory that are used to further determine the reduction in entropy for each trajectory. Strategy planner 106 then generates an exploration cost for each trajectory based on the required movement of the vehicle compared to the reduction in entropy, and may select a trajectory based on the exploration cost and the predicted reduction in entropy associated with the trajectory (e.g., selecting a path that results in a highest reduction in entropy).

Using the generated trajectory from strategy planner 106, controller 108 (e.g., controller 310 described below) converts the trajectory to control instructions and navigates and/or controls vehicle 110 according to the generated trajectory. During or after execution of the trajectory by controller 108, system 100 may continue to collect data using perception module 102 and periodically update trajectory based on the outputs from spot occupancy estimator 104 and/or strategy planner 106.

In some embodiments, one or more elements of system 100 may be implemented as a trained machine learning model configured to generate a corresponding output. For example, system 100 may include one or more trained machine learning models configured to, at least, identify objects, parking spaces, and actors based on received sensor data, detect parking space occupancy, generate confidence values for detections (e.g., detected spaces, occupancy status, and/or objects), determine entropy associated with an occupancy map, and/or generate trajectories for a vehicle. The one or more machine learning models may be trained based on historical data, for example, using historical identifications of objects, occupancy maps, confidence values, and/or trajectories. The one or more machine learning models may be trained in a staged training process using a plurality of training stages. For example, the one or more machine learning models may be trained in a first stage using a first set of historical data and a second stage using a second set of historical data. The second set of historical data may be distinct from the first set of historical data or may be generated by applying one or more transformations and/or alterations to the first set of historical data, for example, by applying image transformations, adding noise, labeling data, and/or obfuscating portions of data.

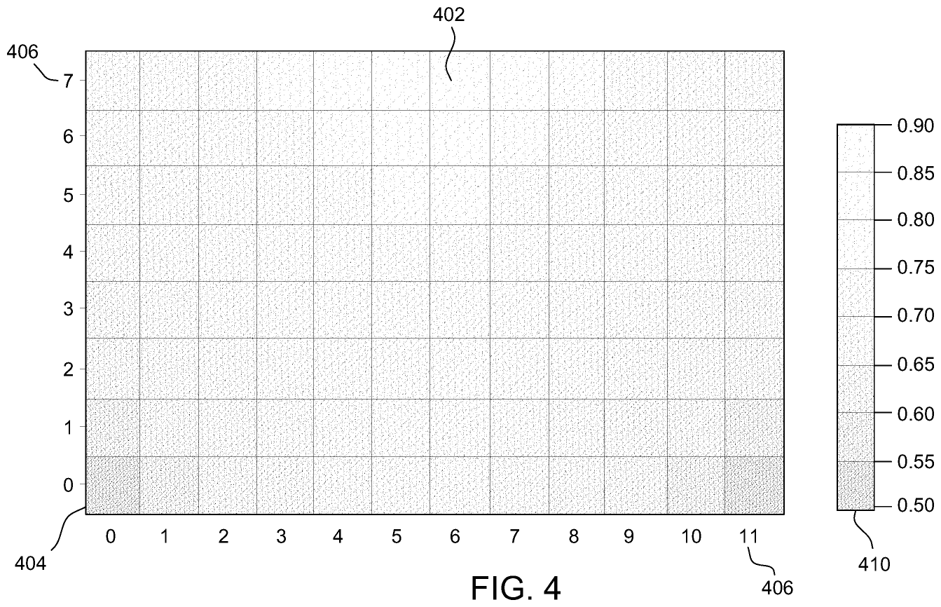

FIG. 2 is a simplified diagram of a parking environment map 200 in which an autonomous vehicle 202 operates. Map 200 may be generated using data collected from perception module 102 and/or obtained from an external source, such as an external map database. Map 200 includes one or more parking spaces, where each space may be a vacant space 204 or a non-vacant space 206. Each parking space may be associated with a centroid 208 which defines the center of the parking space. Each centroid 208 may include a set of cartesian coordinates (e.g., X, Y, and/or Z values) that define the position of the centroid 208. Map 200 may include occupancy data for each parking space, including a current occupancy status as a probability that the spot is vacant (as shown in FIG. 4), an entropy values associated with the space, a likelihood that the space will become vacant within a period of time, and/or other data associated with the occupancy status and/or future occupancy status of the parking space.

Map 200 may include one or more dynamic agents, such as vehicles 210 and/or pedestrians 214. Map 200 may include predicted trajectories (e.g., as predicted by system 100) for each dynamic agent. Each predicted trajectory may include the current location of the dynamic agent and a prediction of the location of the dynamic agent at various points in time in the future. For example, map 200 may include predicted vehicle trajectories 212 for each vehicle and predicted pedestrian trajectories 216 for each pedestrian.

Map 200 may further include an indication of the full FoV 220 of autonomous vehicle 202. The partial FoV 230 is also displayed, showing the reduced distance in which data is collected and/or filtered by perception module 102. The partial FoV 230 may be biased to one side of the vehicle, such as being biased to the front of the vehicle to account for the heading of the vehicle (e.g., parking operations are more concerned with spaces in front of the vehicle as opposed to spaces behind the vehicle).

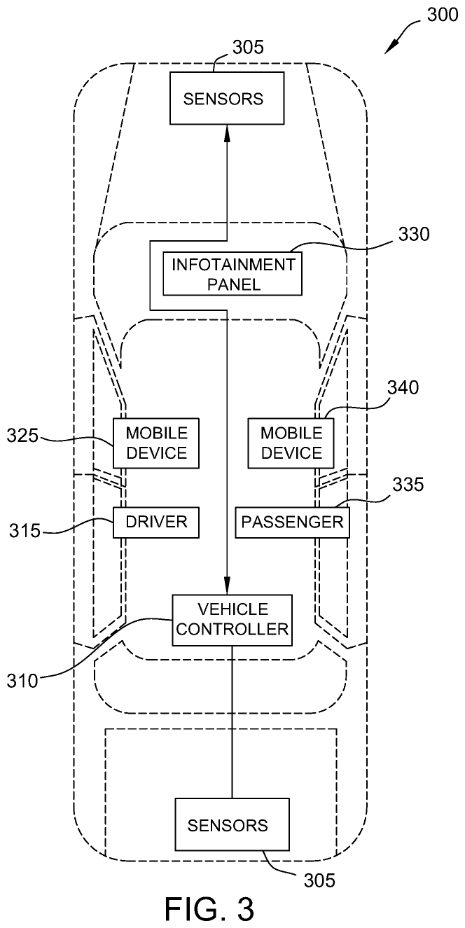

FIG. 3 depicts a top view of an exemplary vehicle 300, in accordance with one embodiment of the present disclosure. In some embodiments, vehicle 300 may be an autonomous or semi-autonomous vehicle capable of fulfilling the transportation capabilities of a traditional automobile or other vehicle. In some embodiments, vehicle 300 may be capable of sensing its environment and navigating without human input. In some embodiments, vehicle 300 is a manual vehicle or a semi-autonomous vehicle with driver assistance systems, such as, but not limited to, lane keep assistance, adaptive cruise control, and/or parallel parking assistance, where vehicle 300 may be a traditional automobile that is controlled by a driver 315.

Vehicle 300 may include a plurality of sensors 305 and a vehicle controller 310 (e.g., controller 310). In the example embodiment, plurality of sensors 305 may detect the current interior and exterior environment of vehicle 300 and the location of vehicle 300, and vehicle controller 310 is configured to process and interpret sensor data captured by sensors 305 to perform various control functions. Sensors 305 may include, for example, cameras, audio capture devices (e.g., microphones), audio recorders, and computer vision. In some embodiments, sensors 305 include cameras, LIDAR, radar, proximity detectors, and/or other sensors 305 that provide information about the surroundings of the vehicle 300, such as, but not limited to, person(s) outside and proximate to vehicle 300, other vehicles, obstacles, traffic flow information including road signs, traffic lights, and other traffic information, and/or other environmental information.

In some embodiments, sensors 305 may additionally include, but are not limited to only including, odometer, speedometer, accelerometers, wheel sensors, radar, LIDAR, proximity sensors, ultrasonic sensors, electromagnetic sensors, wide RADAR, long distance RADAR, Global Positioning System (GPS), video devices, imaging devices, cameras, audio recorders, and computer vision. Sensors 305 may also include sensors that detect conditions of vehicle 300, such as covered distance, speed, acceleration, gear, braking, and other conditions related to the operation of vehicle 300, for example: at least one of a measurement of at least one of time, speed, direction, rate of acceleration, rate of deceleration, location, position, orientation, and/or rotation of the vehicle, and/or a measurement of one or more changes to at least one of time, speed, direction, rate of acceleration, rate of deceleration, location, position, orientation, and/or rotation of the vehicle.

In the example embodiment, vehicle controller 310 is able to communicate with one or more remote computer devices, such as a database (e.g, a map database), a mobile device 325 of driver 315 and a mobile device 340 of passenger 335. Mobile device 325 may include, but is not limited to only including, a cellular phone, a smart phone, a tablet, and/or any other portable computing device brought into and/or removed from vehicle 300. Vehicle controller 310 may communicate with mobile device(s) 325, 340 wirelessly, such as via a wireless near-field network (e.g., Bluetooth®, a registered trademark of Bluetooth SIG, Inc.) or via a cellular network. In some embodiments, vehicle controller 310 may detect the presence of mobile device(s) 325, 340 within vehicle 300 based on their mobile device(s) wirelessly pairing with vehicle controller 310. In some embodiments, vehicle controller 310 may communicate with one or more remote computer devices or one of mobile devices 325, 340 to query and/or receive data from third-party sources, such as weather data, map data, and/or traffic data.

In the example embodiment, vehicle 300 further includes an infotainment panel 330. Vehicle controller 310 may receive user input from driver 315 or passenger 335 via infotainment panel 330 and/or mobile device(s) 325, 340. Such user input may include, for example, user preferences or control commands. Vehicle controller 310 may also provide output(s) to driver 315 or passenger 335 via infotainment panel 330 and/or mobile device(s) 325, 340. Infotainment panel 330 may include a display, wherein the display is capable of receiving input from a user through the display itself (e.g., touch activation of the infotainment panel) and/or by receiving input from a remote computing device (e.g., a mobile phone) or one or more buttons inside the vehicle. For example, driver 315 or passenger 335 may use infotainment panel 330 to enter autonomous parking preferences (e.g., prioritize shortest distance to a store, prioritize shortest waiting time, etc.).

In the example embodiment, vehicle controller 310 may be responsive to voice commands issued by a requestor, including driver 315 or passenger 335. Vehicle controller 310 detects that an occupant of vehicle 300—that is, the requestor —has issued a verbal activation command, directed to voice assistant functionality of vehicle 300 (e.g., of vehicle controller 310). Vehicle controller 310 may further cause activation of a voice assistant functionality of the corresponding computing device such that the computing device is activated for receipt of additional verbal commands from the user, or may interpret the voice command to activate one or more vehicle features in response to the voice command, such as initiating an autonomous parking operation.

In some embodiments, vehicle 300 may include autonomous or semi-autonomous vehicle-related functionality or technology. In some embodiments, the autonomous or semi-autonomous vehicle-related functionality or technology may be controlled, operated, and/or in communication with vehicle controller 310. In some embodiments, vehicle controller 310 includes a plurality of controllers associated with different sensors 305 and/or controls of the vehicle 300. In some embodiments, the plurality of controllers are in communication with each other, such as through a Controller Area Network (e.g., CAN bus) (not shown). Moreover, although vehicle 300 may be an automobile in the exemplary embodiment, in other embodiments, vehicle 300 may be, but is not limited to only being, a bus, a low-speed vehicle, a motorcycle, a utility task vehicle, a truck, construction equipment, and/or any other type of vehicle.

FIG. 4 illustrates an exemplary occupancy map 400 in accordance with one embodiment of the present disclosure. In the example shown, occupancy map 400 represents an initial occupancy probability for spaces in a parking lot (as shown in FIG. 2). Each spot may be associated with a row 406 and column 408 of the parking lot, with each spot having a probability 410 ranging between 0 and 1 representing the likelihood that the spot is occupied. System 100 may update occupancy map 400 based on received sensor data as vehicle 110 traverses the parking lot. In the example shown, spot 402 has a probability of 0.9 (90%) of being occupied, representing a high likelihood that the spot is occupied. Spot 404 has a probability of 0.5 (50%) of being occupied, representing a lower likelihood that the spot is occupied.

In some embodiments, each spot may further be associated with a confidence value and an entropy value. The confidence value reflects the confidence with which the occupancy status was determined, for example, a spot that was only partially observed (e.g., the spot was outside of partial FoV 230 or the centroid of the spot was not fully observed) may have a lower confidence value than a spot that was fully observed. The entropy value may reflect a time since the spot was last observed and the confidence value associated with the last observation of the spot. For example, if a spot was last observed a long time ago with low confidence, the spot may have a high entropy value, while a spot that was last observed recently with high confidence has a low entropy value.

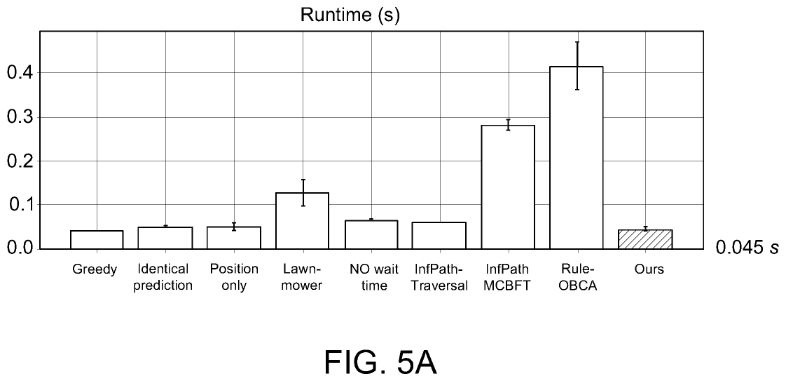

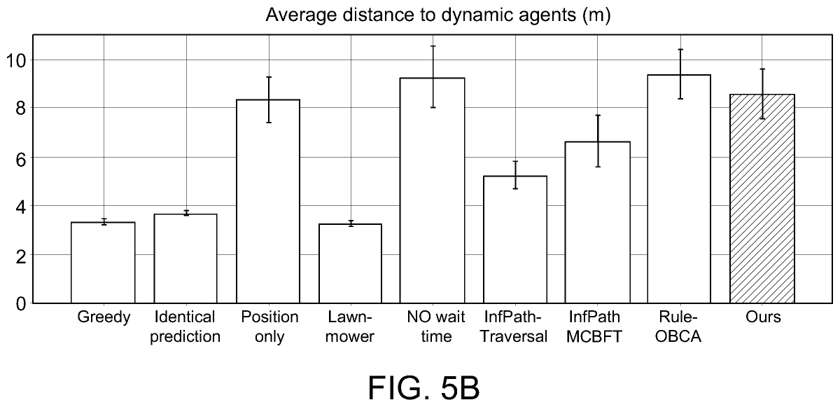

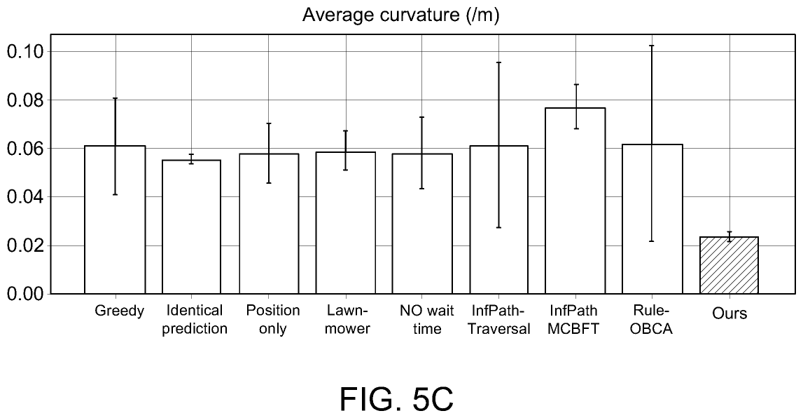

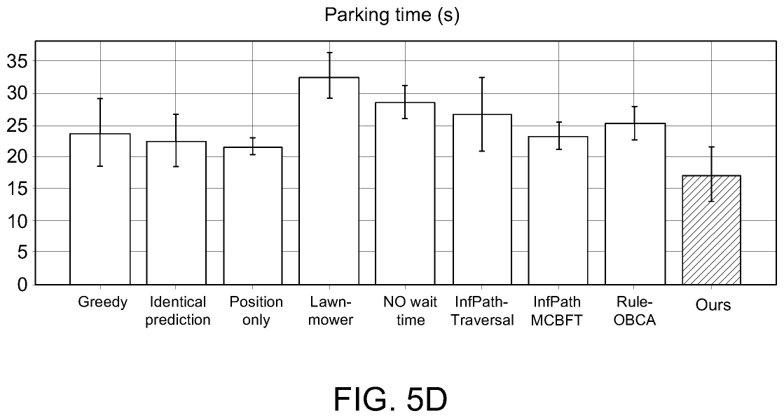

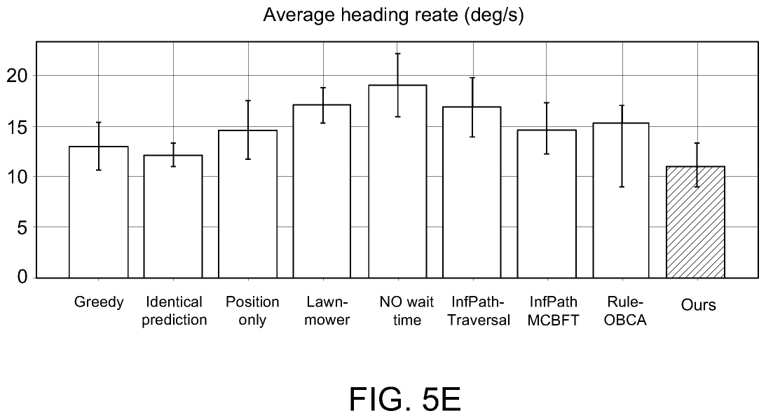

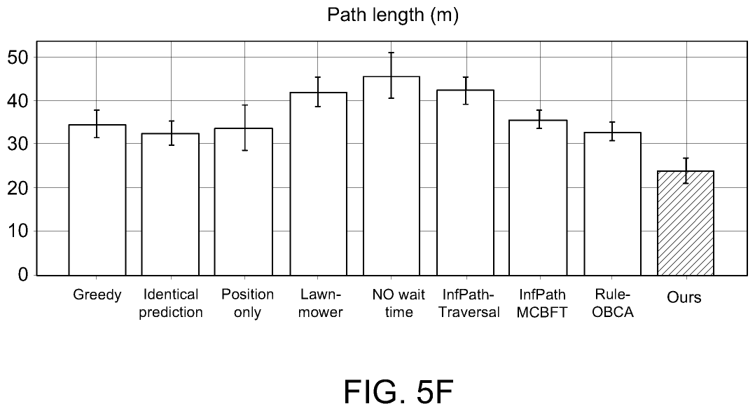

FIGS. 5A-5F illustrate graphs of various metrics associated with trajectories generated by an exemplary embodiment of system 100, including at least parking time, average heading rate, path length, average curvature, minimum distance to static obstacles, average distance to dynamic agents, and runtime. For example, FIGS. 5A-5F illustrate a decreased runtime (e.g., computational time to plan and generate trajectories) when compared to other trajectory generation solutions, an increased minimum distance to dynamic agents, increasing the safety of the trajectories, decreased parking time, path lengths, average heading rates, and average curvatures, showing an increase in efficiency and smoothness of generated trajectories. When taken together, FIGS. 5A-5F illustrate that system 100 generates safe, smooth trajectories which account for dynamic agents more quickly than existing trajectory generation systems.

### Exemplary Process for Autonomous Vehicle Parking

The following section provides an overview of the parking occupancy estimation and strategy planning process, as implemented by, for example, system 100. The exemplary process described herein is non-limiting.

In the given exemplary scenario, an ego vehicle navigates a parking lot, equipped with onboard sensors that provide observations of spot occupancy within a partial FoV, along with motion predictions of dynamic agents such as vehicles and pedestrians. The task for the ego is to plan trajectories that efficiently explore the lot, identify an available spot, and park safely.

Consider the parking lot shown in FIG. 2 with Nₚ spots, whose centers are given by P={s₁, . . . , s_{Np}}, where sᵢ denotes the 2D coordinates of spot i. The ego vehicle has prior access to a static map of the lot (boundaries and lane centerlines/widths), but spot occupancy is unknown and must be observed in real time. Boundaries are treated as static obstacles, and vehicle dynamics are modeled using a kinematic bicycle model that is suitable for low-speed maneuvers. The vehicle state is x=[X, Y, θ]^{T}, where (X, Y) is the rear axle center and heading is θ, while controls are longitudinal velocity v and front-wheel steering angle δ.

The vehicle's onboard sensing is modeled via a “scaled and shifted” infinity norm defining the FoV, though other shapes (e.g., ellipses or circles) can be modeled by modifying the distance metric. This formulation captures the limited and imperfect nature of real-world observations.

The scaled and shifted distance between the ego vehicle at state x=[X, Y, θ]^{T} and a point s∈ [symbol] is defined as:

$${d}_{( Ϛ , r )} ( x , s ) = {‖ {r}^{T} {R ( θ )}^{T} ( s - ( [ \begin{matrix}X \\ Y\end{matrix} ] + R ( θ ) [ \begin{matrix}Ϛ \\ 0\end{matrix} ] ) ) ‖}_{∞} ,$$

$$such that r = [ \begin{matrix}\frac{1}{{r}_{x}} & {\frac{1}{{r}_{y}} ]}^{T} , R ( θ ) = [ \begin{matrix}cos ( θ ) & - sin ( θ ) \\ sin ( θ ) & cos ( θ )\end{matrix} ] ,\end{matrix}$$

Where rₓ and r_{y} are the half-lengths of the FoV rectangle along the longitudinal and lateral directions, respectively, while [symbol] is the forward shift in ego frame to bias the sensing region ahead of the vehicle. The rotation matrix R(θ) transforms vectors from the ego frame to the world frame.

The observability of a spots E P from vehicle state x is defined as:

$$Spot s is \{ \begin{matrix}fully observed if & {d}_{( Ϛ , r )} ( x , s ) \leq ϵ , \\ unobserved if & {d}_{( Ϛ , r )} ( x , s ) \geq γ , \\ partially observed & otherwise ,\end{matrix}$$

Where ∈<γ and are obtained from the vehicle sensing limits. The different observability regions are illustrated in FIG. 2 (e.g., the area within the partial FoV 230, and the area outside of FoV 220, and the area within FoV 220 but outside of partial FoV 230).

System determines an observation accuracy for each observation, where Let

$${O}_{t}^{s} ∈ \{ 0 , 1 \}$$

be the ground-truth occupancy and

$${Z}_{t}^{s} ∈ \{ 0 , 1 \}$$

be the observed occupancy of spot s at time t, where 1:=occupied and 0:=vacant. Observation accuracy is the likelihood of correctly observing spot s, modeled using the distance-dependent probability

$${p}_{c} ( {d}_{( Ϛ , r )} ( x , s ) ) = P ( {Z}_{t}^{s} = 1 \vert {O}_{t}^{s} = 1 ) = P ( {Z}_{t}^{s} = 0 \vert {O}_{t}^{s} = 0 ) ,$$

$${p}_{c} ( {d}_{( Ϛ , r )} ( x , s ) ) = {e}^{- l n ( 2 ) {( 1 + {e}^{- {α}_{c} ( {d}_{( Ϛ , r )} ( x , s ) - ( \frac{γ - ϵ}{2} + ϵ ) )} )}^{- 1}} ,$$

where p_{c}(d) is the exponential of a scaled sigmoid centered at

$$\frac{γ - ϵ}{2} + ϵ ,$$

such that, such that p_{c}(d)→1 as d decreases to ∈ and p_{c}(d) decreases to 0.5 as d →y. The distance-dependent probability models observation confidence degrading with distance from ego vehicle, unlike existing solutions which may assume fixed uncertainty.

Given the ego vehicle state xₜ∈ [symbol] ³ at time t, parking space observations

$$Z ( \begin{matrix}s \\ t\end{matrix} )$$

as defined above, predictions of D dynamic agents as

$${\{ {\{ {\hat{y}}^{j} ( k ) \}}_{k = t}^{t + T} \}}_{j = 1}^{D}$$

over a horizon T, where ŷ^{j}(k)∈ [symbol] ³ is the position and heading of agent j if agent j is a vehicle, and ŷⱼ(k)∈ [symbol] ² is the position if agent j is a pedestrian; the system may compute a reference trajectory that satisfies the vehicle dynamics and steers the vehicle toward a feasible parking space or explores the lot while avoiding static and dynamic obstacles.

The perception module provides dynamic agent predictions and occupancy observations using the partial FoV model, and the occupancy estimator recursively updates spot data to predict future spot availability. The strategy planner computes and evaluates feasible paths, corresponding to one of the three actions: park immediately, wait, or explore the lot by minimizing a cost that accounts for efficiency and safety. The chosen trajectory is executed by the vehicle controller (e.g, controller 108, controller 310), closing the loop.

At each planning step t, the spot occupancy estimator predicts occupancy probabilities for all spots in the lot over a time horizon T, combining current observations with predicted motion of dynamic agents (e.g., dynamic agents as described above with respect to FIGS. 1-3). This enables the ego vehicle (e.g., vehicle 110) to plan based on anticipated occupancies rather than instantaneous observations. Probabilities may be computed via a Bayes filter, with the prediction step modeling agent interactions and the update step incorporating FoV observations.

For each dynamic agent, each agent j's position at time k is modeled as a Gaussian, where ŷ^{j}(k) is the nominal prediction and Σk is the covariance:

y^{j}(k)~N(ŷ^{j}(k)Σ(k)), k∈(t, . . . , t+T)

These uncertain trajectories define the probability that a spot s∈P is occupied by an agent j at time k using a spot probability equation:

p(s,j,k)=E_{d}·A_{f},

E_{d}=((α_{d}+1)(α_{d}+e^{α}^{₁}^{m}^{_{d}}^{(y}^{^{j}}^{(k),s)}))⁻¹

E_{d} captures spatial proximity via the Mahalanobis distance:

m_{d}(y^{j}(k),s)=(ŷ^{j}(k)−s)^{T}Σ(k)⁻¹(ŷ^{j}(k)−s)
using an alignment factor A_{f} that reflects whether the agent is moving toward the spot, based on its predicted velocity v^{j}(k) and velocity uncertainty σᵥ(k). Together, E_{d} and A^{f} encode the intuition that an agent is more likely to occupy a spot if the agent is both closer and moving towards the spot, while accounting for motion uncertainty.

At each timestep, the system may propagate the position covariance using a discrete-time model:

E(k+1)=(θ(k))(Σ(k)+Q)R(θ(k))^{T}
where R(θ(k)) is the rotation matrix, θ(k) is vehicle's heading and Q is a diagonal matrix representing process noise in ego frame. To estimate the uncertainty in velocity, system may use the discrete time model above and the finite difference:

$${v}^{j} ( k ) = \frac{{y}^{j} ( k + 1 ) - {y}^{j} ( k )}{Δ t}$$

From the spot probability equation, the probability that at least one of the D dynamic agents will occupy spot s at time k is given by a future occupancy equation:

$$q ( s , k ) = 1 - {\prod }_{j = 1}^{D} ( 1 - p ( s , j , k ) )$$

At each step k∈{t, . . . , t+T}, the prior belief is predicted using the above equation according to:

$${\overline{b}}_{k}^{s} = P ( {O}_{k}^{s} = 1 )$$

and the system subsequently updates the prior belief with the observations

$$Z ( \begin{matrix}s \\ k\end{matrix} )$$

to obtain the posterior belief:

$${b}_{k}^{s} = P ( {O}_{k}^{s} = 1 \vert {Z}_{k}^{s} )$$

Existing systems may propagate beliefs without considering the effect of dynamic agents on parking spaces. The present system explicitly incorporates dynamic agent motion and models asymmetric interaction with parking spaces. The ego vehicle determines whether the currently occupied spot will become vacant, while determining whether a vacant spot will become occupied in the future. This distinction enables faster parking and smoother trajectories, as shown in, for example, FIG. 5. The current occupancy of a spot is determined from its observation

$$Z ( \begin{matrix}s \\ t\end{matrix} ) .$$

The system may remove and/or not collect occupancy observations and agent interactions outside the FoV.

For initially vacant spots, a transition model emphasizes incoming occupancy, and the prior belief is recursively updated as

$${\overline{b}}_{k + 1}^{s} = q ( s , k + 1 ) ( 1 - {b}_{k}^{s} ) + {μ}_{1} {b}_{k}^{s} ,$$

where

$$q ( s , k + 1 ) = P ( {O}_{k + 1}^{s} = 1 \vert {O}_{k}^{s} = 0 )$$

is computed from the future probability equation, and

$${μ}_{1} = P ( {O}_{k + 1}^{s} = 1 \vert {O}_{k}^{s} = 1 )$$

models the departure probability of a parked vehicle using an exponential distribution, reflecting the memory-less nature of departures. If λ_{d} denotes the average departure rate of a parked vehicle, the probability of departure within a time interval λt is

$$P ( {O}_{k + 1}^{s} = 0 ∣ {O}_{k}^{s} = 1 ) = 1 - {e}^{− {λ}_{d} Δ t} = {μ}_{1} = {e}^{− {λ}_{d} Δ t} .$$

For initially occupied spots, the emphasis of the belief update is on potential departure of the occupied agent, captured as

$$1 - {\overline{b}}_{k + 1}^{s} = {μ}_{2} ( 1 - {b}_{k}^{s} ) + ( 1 - q ( s , k + 1 ) ) {b}_{k}^{s} ,$$

where

$$1 - q ( s , k + 1 ) = P ( ( {O}_{k + 1}^{s} = 0 \vert {O}_{k}^{s} = 1 )$$

is computed using the future occupancy equation and

$${μ}_{2} = P ( {O}_{k + 1}^{s} = 1 \vert {O}_{k}^{s} = 0 )$$

models the arrival probability of a vacant spot using a Poisson distribution, which commonly describes arrival processes. If λₐ denotes the average number of vehicles that arrive with the time interval Δt, the probability that no vehicle parks in a vacant spot is

$$P ( {O}_{k + 1}^{s} = 0 ∣ {O}_{k}^{s} = 0 ) = {e}^{− {λ}_{a}} ⇒ {μ}_{2} = 1 − {e}^{− {λ}_{a}} .$$

For unobservable spots, the prediction equation depends on the average departure rates and arrival rates:

$${\overline{b}}_{k + 1}^{s} = {μ}_{2} ( 1 - {b}_{k}^{s} ) + {μ}_{1} {b}_{k}^{s} .$$

The prior belief

$$\overline{b} ( \begin{matrix}s \\ k + 1\end{matrix} )$$

serves as the input to the update step, where the prior belief is fused with observations.

The update combines current spot observations with

$$\overline{b} ( \begin{matrix}s \\ k + 1\end{matrix} )$$

to estimate future occupancy. For fully observed spots, for example, as given by

p_{c}(d [symbol] _{,r})(xₜ,s)=1,

The system may completely trust the current observation and propagate occupancy using only agent predictions. For partially observed or unobserved spots, for example, as given by

p_{c}(d [symbol] _{,r})(xₜ,s)>1
the system may apply a Bayes' rule equation to fuse the observation with the prior belief:

$${b}_{k + 1}^{s} = \{ \begin{matrix}{\overline{b}}_{k + 1}^{s} & if {p}_{c} ( {d}_{( ζ , r )} ( {x}_{t} , s ) ) = 1 \\ \frac{P ( {Z}_{k + 1}^{s} ∣ {O}_{k + 1}^{s} = 1 ) {\overline{b}}_{k + 1}^{s}}{P ( {Z}_{k + 1}^{s} )} & otherwise\end{matrix} ,$$

where xₜ is the current ego state. Since only the current occupancy observation

$$Z ( \begin{matrix}s \\ t\end{matrix} )$$

is available, the system may set

$$Z ( \begin{matrix}s \\ k + 1\end{matrix} ) = Z ( \begin{matrix}s \\ t\end{matrix} )$$

for all k∈{t, . . . , t+T−1}. For unobserved spots s, from the distance-dependent probability defined above,

p_{c}(d [symbol] _{,r})(xₜ,s)≈1

Hence, using the Bayes' rule equation, the prior belief remains unchanged, as the update equation reduces to:

$${b}_{k + 1}^{s} \approx {b}_{k + 1}^{s}$$

Given the probabilistic forecasts from the spot occupancy estimator (Sec. III), the strategy planner selects actions (park, wait, or explore) and generates a reference trajectory that balances efficiency and safety in dynamic parking scenarios.

At each planning step, the system filters candidate spots inside the FoV based on the occupancy predictions, considering two cases: (i) initially vacant and remains vacant (ii) initially occupied and becomes vacant. Formally, spot s is vacant in the future (t+T) using a predicted vacancy equation if:

$$\{ \begin{matrix}s is initially vacant ( time t ) and {b}_{t + T}^{s} \leq {P}_{v} , \\ s is initially occupied ( time t ) and {b}_{t + T}^{s} \leq {P}_{o} .\end{matrix}$$

This filtering ensures that the strategy planner only considers feasible parking spaces, enhancing decision-making efficiency in dynamic environments. The system sets an indication that a spot is more likely to be occupied if initially vacant (Pᵥ<Pₒ) and vice-versa to reflect the asymmetry in availability reasoning.

At a given planning step t, let Sₜ∈P denote spots classified as vacant by the predicted vacancy equation shown above. The system generates trajectories as

τ={τ_{g}}_{g∈S}_{ₜ}
using a Hybrid A* algorithm (or a spline-based planning algorithm), where each τ_{g} leads to a goal state g from the ego state xₜ. Each trajectory is defined as

$${T}_{g} = {\{ x ( k ) \}}_{k = t}^{t + {N}_{g}} ,$$

where

x(t)=xₜ,x(t+N_{g})=g
and N_{g} is the time required to reach g from xₜ. While static obstacles are considered in trajectory generation, dynamic obstacles are handled using the cost function and waiting time parameter, defined further herein. Trajectory generations and evaluations may be parallelized across all goal states g for efficiency.

The cost function primarily evaluates efficiency (in time and distance), safety (with respect to collision avoidance), and smoothness (with respect to acceleration and gear changes):

$$𝒞 ( {τ}_{g} ) = {N}_{g} + {t}_{w} + {\sum }_{k = t}^{t + {t}_{w}} {c}_{o} ( x ( k ) , 𝓎 ( k ) ) + {\sum }_{k = t + {t}_{w} + 1}^{t + {t}_{w} + {N}_{g}} {c}_{o} ( x ( k − {t}_{w} ) , 𝓎 ( k ) ) + {\sum }_{k = t}^{t + {N}_{g} − 1} {c}_{smooth} ( x ( k ) ) ,$$

$$where$$

$${c}_{o} ( x ( k ) , 𝓎 ( k ) ) = {\sum }_{j = 1}^{D} h ( x ( k ) , {\hat{y}}^{j} ( k ) ) + {\sum }_{i = 1}^{W} h ( x ( t ) , {w}_{i} ) ,$$

$$\begin{matrix}{c}_{smooth} ( x ( k ) ) = & ‖ a ( k ) ‖ + {D}_{C} ( v ( k ) , v ( k + 1 ) ) +\end{matrix} \text{?} ( reverse ( k ) ) + \text{?} ( change\_gear ( k ) ) ,$$

where t_{w} denotes the waiting time (explained further herein), and

$$𝓎 ( k ) = {\{ {\hat{y}}^{j} ( k ) \}}_{j = 1}^{D}$$

represents the configuration of dynamic agents at time k and the static obstacles are given by

$$\{ {w}_{i} \} ( \begin{matrix}W \\ i = 1\end{matrix} ) with {w}_{i} ∈ {ℝ}^{2} .$$

At each time step, cₒ(⋅, ⋅) penalizes proximity to obstacles and cₛₘₒₒₜₕ(⋅) promotes smooth trajectories.
In cₒ(⋅,⋅), the obstacle avoidance cost h(⋅,⋅) is

h(x,y)=e^{-α}^{ₒ}^{d}^{ₒ}^{(x,y),}

Where dₒ(x,y) is the distance between the ego vehicle x and obstacle y. The barrier cost h(⋅,⋅) penalizes proximity to obstacles, with αₒ=2 for dynamic agents and αₒ=3 for static obstacles, reflecting lower penalties for static obstacles. The system may extend a 3-circle distance used to a 5-circle model for dₒ(⋅,⋅) to improve accuracy in dynamic collision avoidance. For static obstacles, the exact distance between the ego vehicle's edge and obstacle points

$$\{ {w}_{i} \} ( \begin{matrix}W \\ i = 1\end{matrix} )$$

is computed, since static obstacles are more reliably perceived. To balance terms, α(t) and the cosine distance are scaled to [0, 1] using velocity limits.

In the cₛₘₒₒₜₕ(x(k)) equation given above, DC(⋅,⋅) is the cosine distance and

α(k)=[\ddot{X}(k),Ÿ(k)]^{T},v(k)=[\dot{X}(k),\dot{Y}(k)]^{T},

$$\text{?} ( reverse ( k ) ) = \{ \begin{matrix}1 , & if {D}_{C} ( v ( k ) , [ \begin{matrix}cos ( θ ( k ) ) \\ sin ( θ ( k ) )\end{matrix} ] ) > 1 , \\ 0 , & otherwise\end{matrix} ,$$

$$\text{?} ( change\_gear ( k ) ) = \{ \begin{matrix}1 , & if {D}_{C} ( v ( k ) , v ( k + 1 ) ) > 1 , \\ 0 , & otherwise .\end{matrix}$$

The system may incorporate wait-and-go behaviors in the trajectories τ_{g} by introducing a waiting time t_{w} in the cost function. This enables the ego vehicle to pause and yield to dynamic agents before moving to park in a spot g, thereby reducing collision risks in constrained parking lots. To ensure feasibility of a waiting trajectory, the system may impose a maximum wait time T_{w} and consider only paths with t_{w}≤T_{w}. The value of T_{w} may be set based on parking lot density, and in some embodiments, may be dynamically adapted to account for congestion in the parking environment.

If T<N_{g}, the system may extrapolate the predictions using a constant velocity model for all k≥t+T+1 and j∈{1, 2, . . . , D} where

$${\hat{υ}}^{j} ( k ) = \frac{{\hat{y}}^{j} ( k + 1 ) − {\hat{y}}^{j} ( k )}{Δ t}$$

Once the system has computed and evaluated the trajectories T, the system may choose the one that has the minimum cost according to

argrmin_{τ∈T}C(τ)
and avoids all obstacles while respecting the safety thresholds.

The system may set larger safety thresholds for dynamic agents, for example, 50 cm for vehicles and 90 cm for pedestrians, as compared to 20 cm for static obstacles. These values are tailored to parking scenarios but may be adjusted for other applications.

If no feasible trajectory exists to a spot in Sₜ, the ego vehicle switches to exploratory mode, selecting a trajectory that maximizes information gain about spot occupancy. In typical parking lots (e.g., as shown in FIG. 2), maneuver options are limited to continuing straight within a row, entering a row from outside, or turning left or right at the end. This may be generalized by evaluating paths to a finite set of exploration goals ε∈ [symbol] ³, where each e∈ε represents a candidate goal pose.

The system may define one or more exploration goals, for example, three exploration goals ε={e₁, e₂, e₃} at each time step: going straight (e₁), turning left (e₂), and turning right (e₃). These options suit structured parking lots with parallel rows (FIG. 2), though may be extended to more general layouts such as multi-level garages with verticality in future work (e.g., including more complex goal such as “ascend a parking lot level”). The “going straight” goal is:

$${ϵ}_{1} = [ \begin{matrix}R ( {θ}_{i} ) [ \begin{matrix}ϵ − η \\ 0\end{matrix} ] + [ \begin{matrix}{X}_{t} \\ {Y}_{t}\end{matrix} ] \\ {θ}_{t}\end{matrix} ] ,$$

and the ego state is given by:

xₜ=[Xₜ,Yₜ,θₜ]^{T},
where ∈ is the full observability threshold, and η∈[0,∈)=denotes how far the ego vehicle moves forward. Left and right turn goal states for right-hand traffic conventions are given by

$${\text{?}}_{σ} = [ \begin{matrix}R ( {θ}_{t} ) [ \begin{matrix}{x}_{road} + σ \cdot ( \frac{l \text{?}}{2} ) \\ σϵσ\end{matrix} ] + [ \begin{matrix}{X}_{t} \\ {Y}_{t}\end{matrix} ] \\ {θ}_{t} + σ \cdot ( \frac{π}{2} )\end{matrix} ] , σ ∈ \{ + 1 , − 1 \} ,$$

$$\text{?} \text{indicates text missing or illegible when filed}$$

where e₂=e₊₁(left), e₃=e₋₁(right), x_{road} is the center of the newly observed road, and l_{w} its lane width.

To determine information gain from trajectories, the system may use Hybrid A* (or another similar algorithm) to generate trajectories to e₂ and e₃, and a 5th-order spline to interpolate from τₜ to e₁. Let τ′={τₑ}ₑ∈ε denote the set of trajectories to each exploration goal. The information gain of a trajectory is evaluated using the entropy [symbol] (⋅) of a spot s at time k:

$$ℋ ( {b}_{k}^{s} ) = − {b}_{k}^{s} {log}_{2} ( {b}_{k}^{s} ) − ( 1 − {b}_{k}^{s} ) {log}_{2} ( 1 − {b}_{k}^{s} ) ,$$

$${b}_{k}^{s} = P ( {O}_{k}^{s} = 1 ∣ {Z}_{k}^{s} )$$

Future observations may be simulated for each trajectory τₑ according to:

$${\{ {Z}_{k}^{s} \}}_{k = t + 1}^{t + T}$$

$$Z ( \begin{matrix}s \\ k\end{matrix} ) ( {τ}_{e} )$$

is denoted to be the observation of spot s at time k when the ego vehicle follows trajectory τₑ. Then, the system may recursively update beliefs

$$b ( \begin{matrix}s \\ k\end{matrix} ) ( {τ}_{e} )$$

using the update rule (as described with respect to Bayes' rule above) and the simulated observations

$$Z ( \begin{matrix}s \\ k\end{matrix} ) ( {τ}_{e} )$$

for each τₑ. The total information gain of a trajectory is defined using the entropy reduction of all parking spaces when following the trajectory τₑ:

$$ℒ ( {τ}_{e} ) = {{\sum }_{i = 1}}^{{N}_{p}} ( ℋ ( {b}_{t}^{{s}_{i}} ( {τ}_{e} ) ) - ℋ ( {b}_{t + {N}_{e}}^{{s}_{i}} ( {τ}_{e} ) ) ,$$

where Nₑ is the length of:

$${τ}_{e} = {\{ x ( k ) \}}_{k = t}^{t + {N}_{e}} .$$

To balance exploration with motion efficiency, the system may use the total information gain and the cost function to define the exploration cost as

Cₑ(τₑ)=C(τₑ)−I(τₑ)

The system may select the optimal trajectory as

arg min_{τ}_{_{∈}}_{∈τ},Cₑ(τₑ),
subject to safety thresholds. If no safe trajectory exists, a contingency planner keeps the vehicle stationary or steers it away from adversarial dynamic agents on a collision course.

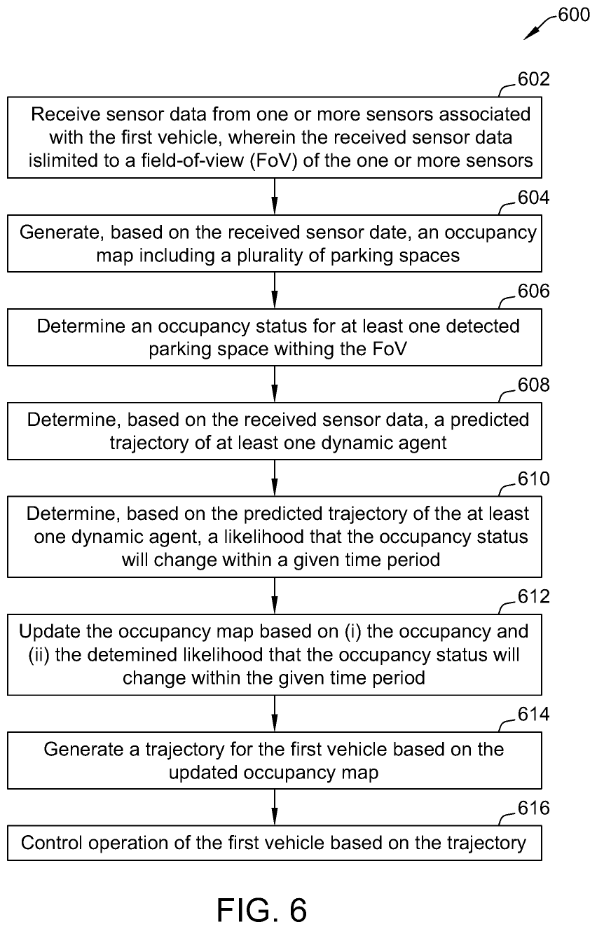

FIG. 6 depicts a flow chart of an exemplary computer-implemented method 600 for controlling navigation of a vehicle for autonomous parking operations in accordance with the present disclosure. In the exemplary embodiment, computer-implemented method 600 may be performed by system 100 shown in FIG. 1.

Method 600 may include receiving 602 sensor data from one or more sensors associated with the first vehicle, wherein the received sensor data is limited to a field-of-view (FoV) of the one or more sensors. Method 600 may further include generating 604, based on the received sensor data, an occupancy map including a plurality of parking spaces. Method 600 may further include determining 606 an occupancy status for at least one detected parking space within the FoV. Method 600 may further include determining 608, based on the received sensor data, a predicted trajectory of at least one dynamic agent. Method 600 may further include determining 610, based on the predicted trajectory of the at least one dynamic agent, a likelihood that the occupancy status will change within a given time period. Method 600 may further include updating 612 the occupancy map based on (a) the occupancy status and (b) the determined likelihood that the occupancy status will change within the given time period. Method 600 may further include generating 614 a trajectory for the first vehicle based on the updated occupancy map. Method 600 may further include controlling 616 operation of the first vehicle based on the trajectory.

In some embodiments, method 600 further includes generating a plurality of candidate trajectories for the first vehicle based on the updated occupancy map and computing a respective cost associated with each of the plurality of candidate trajectories based on a cost function, wherein generating the trajectory for the first vehicle includes selecting a trajectory of the plurality of candidate trajectories based on the respective cost associated with each of the plurality of candidate trajectories.

In some embodiments, method 600 further includes determining that no candidate trajectory of the plurality of candidate trajectories can be executed safely by comparing the plurality of candidate trajectories to one or more safety thresholds and controlling the vehicle to wait an amount of time before generating a new plurality of candidate trajectories.

In some embodiments, the cost function includes at least one of (i) an efficiency weight including at least one of a time and distance associated with the candidate trajectory or (ii) a safety weight including at least a computed distance from one or more objects during the candidate trajectory.

In some embodiments, the cost function includes a weight based on a waiting time associated with the candidate trajectory.

In some embodiments, the generated trajectory includes an instruction to explore an area of the occupancy map.

In some embodiments, method 600 further includes determining an entropy associated with one or more areas of the occupancy map, wherein the entropy is based on at least one of (i) the time since the one or more areas were last observed or (ii) a confidence value associated with the received sensor data corresponding to the one or more areas and generating a plurality of candidate trajectories for the first vehicle based on the updated occupancy map, wherein generating the trajectory for the first vehicle includes selecting a trajectory of the plurality of candidate trajectories by determining which trajectory results in the highest reduction in entropy for the one or more areas of the occupancy map.

In some embodiments, method 600 further includes updating the occupancy status of at least one parking space based at least on (i) a time since the at least one parking space was last observed by the first vehicle and (ii) at least one of a predicted arrival rate or a predicted departure rate associated with the at least one parking space.

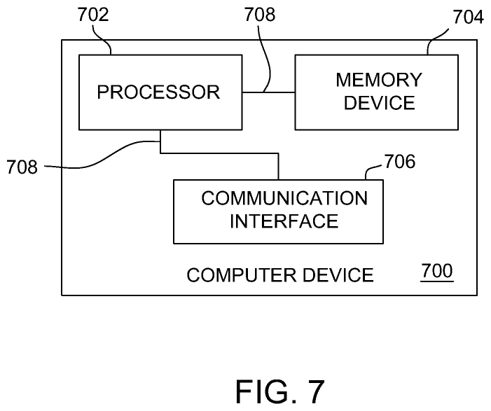

FIG. 7 is a block diagram of an example computing device 700.

Computing device 700, which may be similar to controller 108 (see FIG. 1), includes a processor 702 and a memory device 704. Processor 702 is coupled to memory device 704 via a system bus 708. The term “processor” refers generally to any programmable system including systems and microcontrollers, reduced instruction set computers (RISC), complex instruction set computers (CISC), application specific integrated circuits (ASIC), programmable logic circuits (PLC), and any other circuit or processor capable of executing the functions described herein. The above examples are example only, and thus are not intended to limit in any way the definition or meaning of the term “processor.”

In the example embodiment, memory device 704 includes one or more devices that enable information, such as executable instructions or other data (e.g., sensor data), to be stored and retrieved. Moreover, memory device 704 includes one or more computer readable media, such as, without limitation, dynamic random access memory (DRAM), static random access memory (SRAM), a solid state disk, or a hard disk.

In the example embodiment, the memory device 704 stores, without limitation, application source code, application object code, configuration data, additional input events, application states, assertion statements, validation results, or any other type of data. The computing device 700, in the example embodiment, may also include a communication interface 706 that is coupled to processor 702 via system bus 708.

In the example embodiment, processor 702 may be programmed by encoding an operation using one or more executable instructions and providing the executable instructions in memory device 704. In the example embodiment, processor 702 is programmed perform functions such as those described herein with respect to FIG. 6.

In operation, a computer executes computer-executable instructions embodied in one or more computer-executable components stored on one or more computer-readable media to implement aspects of the disclosure described or illustrated herein. The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random-access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose the various embodiments, and also to enable a person having ordinary skill in the art to practice the various embodiments, including making and using any devices or systems and performing any incorporated methods. The patentable scope of the various embodiments is defined by the claims, and may include other examples that occur to those skilled in the art. Such other examples are intended to be within the scope of the claims if the examples have structural elements that do not differ from the literal language of the claims, or the examples include equivalent structural elements with insubstantial differences from the literal language of the claims.

What is claimed is:

1. A computer system for executing parking operations for a first vehicle, the computer system comprising at least one processor and at least one memory in communication therewith, the at least one processor programmed to:
receive sensor data from one or more sensors associated with the first vehicle, wherein the received sensor data is limited to a field-of-view (FoV) of the one or more sensors;
generate, based on the received sensor data, an occupancy map including a plurality of parking spaces;
determine an occupancy status for at least one detected parking space within the FoV;
determine, based on the received sensor data, a predicted trajectory of at least one dynamic agent;
determine, based on the predicted trajectory of the at least one dynamic agent, a likelihood that the occupancy status will change within a given time period;
update the occupancy map based on (i) the occupancy status and (ii) the determined likelihood that the occupancy status will change within the given time period;
generate a trajectory for the first vehicle based on the updated occupancy map; and
control operation of the first vehicle based on the trajectory.

2. The computer system of claim 1, wherein the at least one processor is further programmed to:
generate a plurality of candidate trajectories for the first vehicle based on the updated occupancy map; and
compute a respective cost associated with each of the plurality of candidate trajectories based on a cost function,
wherein generating the trajectory for the first vehicle includes selecting a trajectory of the plurality of candidate trajectories based on the respective cost associated with each of the plurality of candidate trajectories.

3. The computer system of claim 2, wherein the at least one processor is further programmed to:
determine that no candidate trajectory of the plurality of candidate trajectories can be executed safely by comparing the plurality of candidate trajectories to one or more safety thresholds; and
control the vehicle to wait an amount of time before generating a new plurality of candidate trajectories.

4. The computer system of claim 2, wherein the cost function includes at least one of (i) an efficiency weight including at least one of a time and distance associated with the candidate trajectory and (ii) a safety weight including at least a computed distance from one or more objects during the candidate trajectory.

5. The computer system of claim 2, wherein the cost function includes a weight based on a waiting time associated with the candidate trajectory.

6. The computer system of claim 1, wherein the generated trajectory maximizes expected information gain over parking spot occupancy.

7. The computer system of claim 6, wherein the processor is further programmed to:
determine an entropy associated with one or more areas of the occupancy map, wherein the entropy is based on at least one of (i) the time since the one or more areas were last observed or (ii) a confidence value associated with the received sensor data corresponding to the one or more areas; and
generate a plurality of candidate trajectories for the first vehicle based on the updated occupancy map,
wherein generating the trajectory for the first vehicle includes selecting a trajectory of the plurality of candidate trajectories by determining which trajectory results in the highest reduction in entropy for the one or more areas of the occupancy map.

8. The computer system of claim 1, wherein the processor is further programmed to:
update the occupancy status of at least one parking space based at least on (i) a time since the at least one parking space was last observed by the first vehicle and (ii) at least one of a predicted arrival rate or a predicted departure rate associated with the at least one parking space.

9. The computer system of claim 1, wherein the FoV is biased towards the front of the first vehicle.

10. A computer-implemented method for path planning for a first vehicle, the computer-implemented method performed by at least one processor in communication with at least one memory, the computer-implemented method comprising:
receiving sensor data from one or more sensors associated with the first vehicle, wherein the received sensor data is limited to a field-of-view (FoV) of the one or more sensors;
generating, based on the received sensor data, an occupancy map including a plurality of parking spaces;
determining an occupancy status for at least one detected parking space within the FoV;
determining, based on the received sensor data, a predicted trajectory of at least one dynamic agent;
determining, based on the predicted trajectory of the at least one dynamic agent, a likelihood that the occupancy status will change within a given time period;
updating the occupancy map based on (i) the occupancy status and (ii) the determined likelihood that the occupancy status will change within the given time period;
generating a trajectory for the first vehicle based on the updated occupancy map; and
controlling operation of the first vehicle based on the trajectory.

11. The computer-implemented method of claim 10, further comprising:
generating a plurality of candidate trajectories for the first vehicle based on the updated occupancy map; and
computing a respective cost associated with each of the plurality of candidate trajectories based on a cost function,
wherein generating the trajectory for the first vehicle includes selecting a trajectory of the plurality of candidate trajectories based on the respective cost associated with each of the plurality of candidate trajectories.

12. The computer-implemented method of claim 11, further comprising:
determining that no candidate trajectory of the plurality of candidate trajectories can be executed safely by comparing the plurality of candidate trajectories to one or more safety thresholds; and
controlling the vehicle to wait an amount of time before generating a new plurality of candidate trajectories.

13. The computer-implemented method of claim 11, wherein the cost function includes at least one of (i) an efficiency weight including at least one of a time and distance associated with the candidate trajectory and (ii) a safety weight including at least a computed distance from one or more objects during the candidate trajectory.

14. The computer-implemented method of claim 11, wherein the cost function includes a weight based on a waiting time associated with the candidate trajectory.

15. The computer-implemented method of claim 10, wherein the generated trajectory includes an instruction to explore an area of the occupancy map.

16. The computer-implemented method of claim 15, further comprising:
determining an entropy associated with one or more areas of the occupancy map, wherein the entropy is based on at least one of (i) the time since the one or more areas were last observed or (ii) a confidence value associated with the received sensor data corresponding to the one or more areas; and
generating a plurality of candidate trajectories for the first vehicle based on the updated occupancy map,
wherein generating the trajectory for the first vehicle includes selecting a trajectory of the plurality of candidate trajectories by determining which trajectory results in the highest reduction in entropy for the one or more areas of the occupancy map.

17. The computer-implemented method of claim 10, further comprising:
updating the occupancy status of at least one parking space based at least on (i) a time since the at least one parking space was last observed by the first vehicle and (ii) at least one of a predicted arrival rate or a predicted departure rate associated with the at least one parking space.

18. The computer-implemented method of claim 10, wherein the FoV is biased towards the front of the first vehicle.

19. At least one non-transitory computer readable storage media having computer-executable instructions embodied thereon for path planning for a first vehicle, wherein when executed by at least one processor in communication with at least one memory, the computer-executable instructions cause the at least one processor to:
receive sensor data from one or more sensors associated with a first vehicle, wherein the received sensor data is limited to a field-of-view (FoV) of the one or more sensors;
generate, based on the received sensor data, an occupancy map including a plurality of parking spaces;
determine an occupancy status for at least one detected parking space within the FoV;
determine, based on the received sensor data, a predicted trajectory of at least one dynamic agent;
determine, based on the predicted trajectory of the at least one dynamic agent, a likelihood that the occupancy status will change within a given time period;
update the occupancy map based on (i) the occupancy status and (ii) the determined likelihood that the occupancy status will change within the given time period;
generate a trajectory for the first vehicle based on the updated occupancy map; and
control operation of the first vehicle based on the trajectory.

20. The at least one non-transitory computer readable storage media of claim 19, wherein the computer-executable instructions further cause the at least one processor to:
determine an entropy associated with one or more areas of the occupancy map, wherein the entropy is based on at least one of (i) the time since the one or more areas were last observed or (ii) a confidence value associated with the received sensor data corresponding to the one or more areas; and
generate a plurality of candidate trajectories for the first vehicle based on the updated occupancy map,
wherein generating the trajectory for the first vehicle includes selecting a trajectory of the plurality of candidate trajectories by determining which trajectory results in the highest reduction in entropy for the one or more areas of the occupancy map.
